(19) United States
(12) Patent Application Publication
(10) Pub. No.: US 2013/0073912 A1
(43) Pub. Date: Mar. 21, 2013

(54) INFORMATION PROCESSING DEVICE, SERVICE MANAGEMENT METHOD, AND SERVICE MANAGEMENT PROGRAM

(71) Applicant: Haruka Yoshida, Tokyo (JP)

(72) Inventor: Haruka Yoshida, Tokyo (JP)

(73) Assignee: NEC CORPORATION, Minato-ku, Tokyo (JP)

(21) Appl. No.: 13/520,835

(22) PCT Filed: Dec. 24, 2010
(86) PCT No.: PCT/JP10/73874

§ 371 Date: Jul. 6, 2012

(30) Foreign Application Priority Data
Jan. 7, 2010 (JP) 2010-001968

(51) Int. Cl. G06F 11/30

(52) U.S. Cl. 714/47.1; 714/E11.179

(57) ABSTRACT

When a problem occurs in a service being provided, the degree of influence of the problem is evaluated comprehensively.

An information processing device comprises: an obtaining means which obtains measured values with respect to an item to be monitored relating to an information service; a violation value calculation means which compares a plurality of conditions required relating to the item being monitored with the measured values and calculates a violation value indicating the degree of violation of condition; and an influence degree calculation means which calculates, using the violation value, the degree of influence of the violation of condition on the information service as an influence degree.

### FIELD OF THE INVENTION

The present invention relates to a technology which manages services.

### BACKGROUND OF THE INVENTION

In recent years, organizations and enterprises which utilize an information system for business are increasing. A service provider who provides information services to those organizations and enterprises needs to manage service quality for the service recipients.

Specifically, a system operation administrator detects a service failure (quality level deterioration) caused based on a malfunction, a fault or degradation of a system, and specifies a problem location and its cause and handles it immediately. When the system becomes large in scale, service failures which occur simultaneously generate more often, and in such a case, in order to suppress an influence to the service recipient in minimum, it becomes necessary for the system operation administrator to grasp correctly an influence degree to the service recipient for each failure and judge a handling order. In particular, it is desirable that the system operation administrator decides the handling order so that it may not be against an agreement with the service recipient and judges so that a monetary damage received based on the failure can be suppressed as much as possible.

Under such a status, in patent document 1, a technology is disclosed which determines a sufficiency degree for contract information of services. On the other hand, in patent document 2, a method is disclosed which analyzes a computer infrastructure including a plurality of components which provide services. Here (patent document 2), for an identical service, a plurality of different service level targets is set for each service recipient and an SLO (service level objectives) analyzer described in patent document 2 specifies a service configuration component for which correction is necessary.

Also in patent document 3, a method is disclosed which analyzes a computer infrastructure including a plurality of components which provide services. In particular, in case services are provided for a plurality of service recipients, a satisfaction degree calculation unit described in patent document 3 detects, within an identical service, a service recipient for whom a satisfaction degree is realized 100% and a service recipient for whom it is not realized. And, in patent document 3, a method is described which improves service quality for a service recipient whose satisfaction degree is insufficient by restricting services to a service recipient for whom an excessive satisfaction degree is realized.

### PATENT DOCUMENTS

(Patent document 1) Japanese Patent Application Laid-Open No. 2001-320370

(Patent document 2) Japanese Patent Application Laid-Open No. 2008-108262

(Patent document 3) Japanese Patent Application Laid-Open No. 1997-244973

### SUMMARY OF THE INVENTION

However, in the related technologies mentioned above, in case a problem occurs to provided services, because there were no indexes which integrate influences to different service recipients and which indicate a state of services as a whole, there was a problem that an influence degree of the problem cannot be evaluated comprehensively.

The object of the present invention is to provide an information processing device which solves the problem mentioned above.

### Means for Solving the Problem

In order to achieve the object mentioned above, an information processing device according to the present invention includes: an obtaining means for obtaining measured values with respect to an item to be monitored relating to an information service; a violation value calculation means for comparing a plurality of conditions required relating to the item to be monitored with the measured values and calculating a violation value indicating a degree of violation of condition; and an influence degree calculation means for calculating a degree of influence which the violation of condition gives to the information service as an influence degree using the violation value.

In order to achieve the object mentioned above, a service management method according to the present invention obtains measured values with respect to an item to be monitored relating to an information service; compares a plurality of conditions required relating to the item to be monitored with the measured values and calculates a violation value indicating a degree of violation of condition; and calculates a degree of influence which the violation of condition gives to the information service as an influence degree using the violation value.

In order to achieve the object mentioned above, a service management program according to the present invention makes a computer execute: obtaining processing for obtaining measured values with respect to an item to be monitored relating to an information service; violation value calculation processing for comparing a plurality of conditions required relating to the item to be monitored with the measured values and calculating a violation value indicating a degree of violation of condition; and influence degree calculation processing for calculating a degree of influence which the violation of condition gives to the information service as an influence degree using the violation value.

### Effect of the Invention

According to the present invention, in case a problem occurs to a provided service, an influence degree of the problem can be evaluated comprehensively.

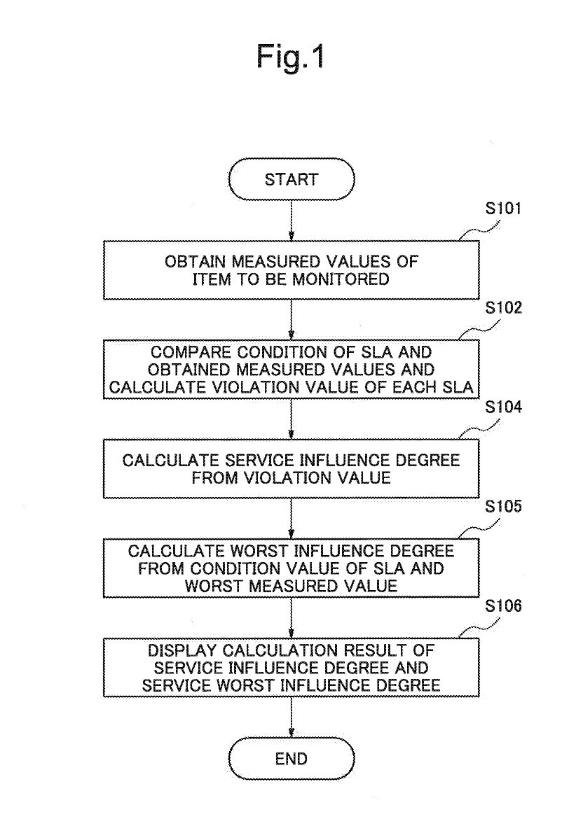

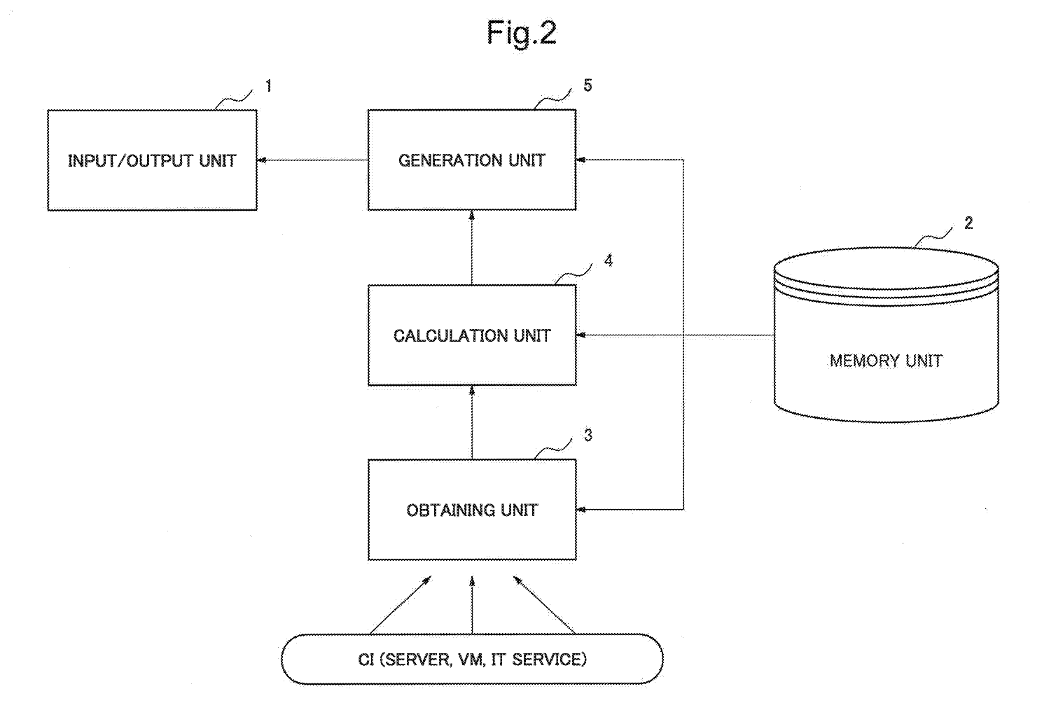

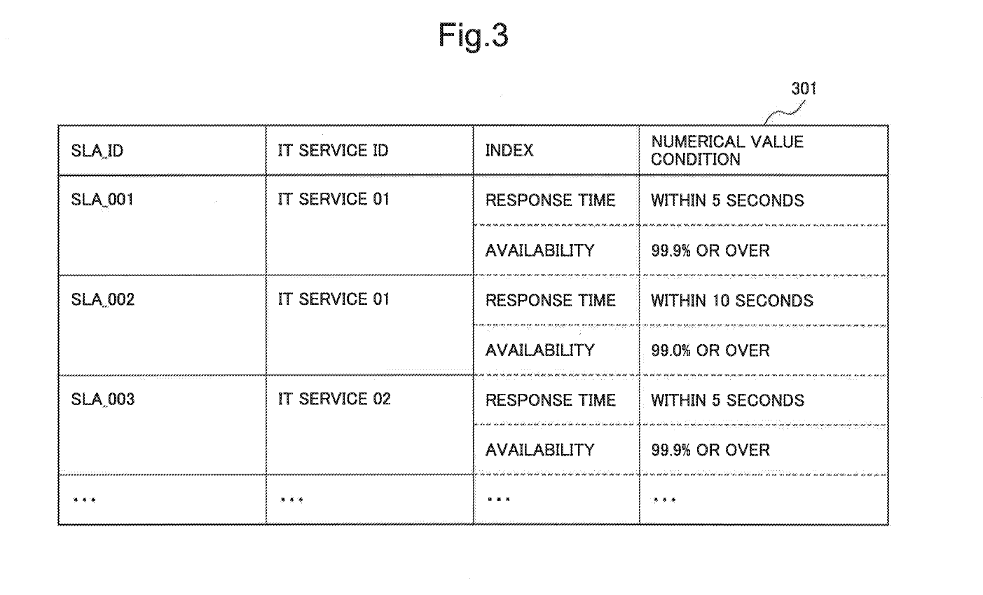

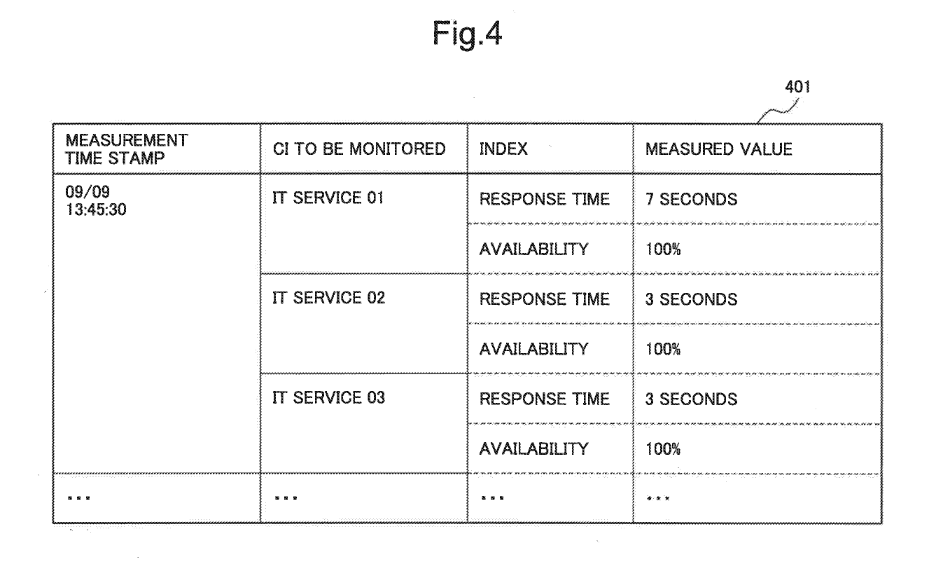

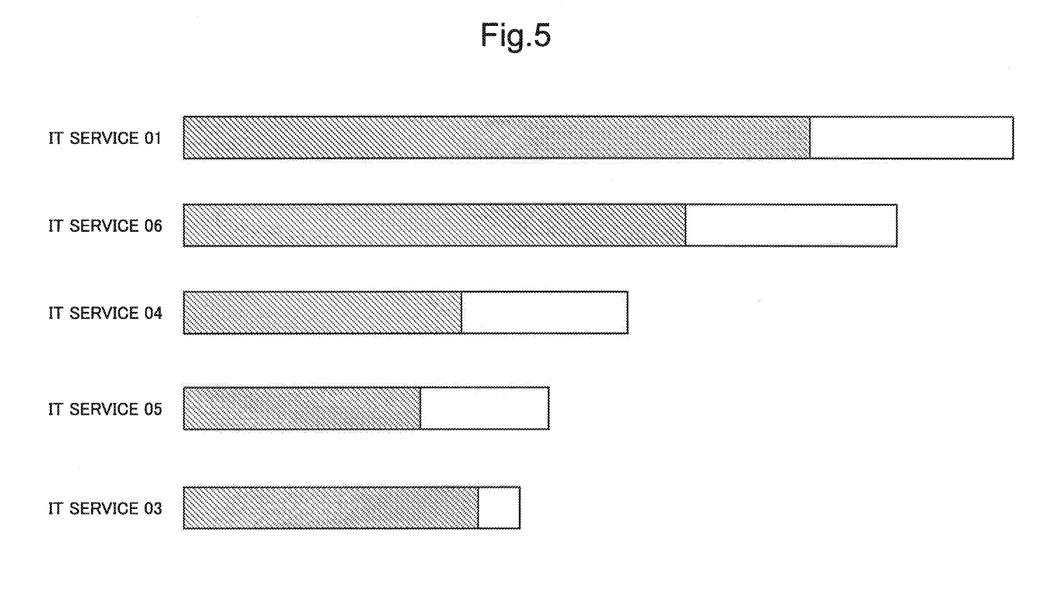

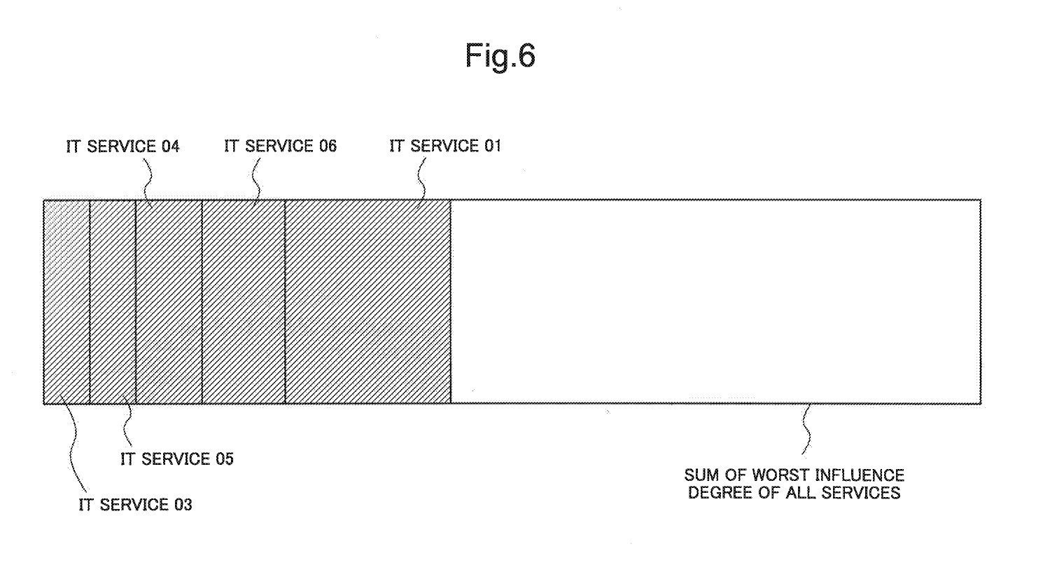

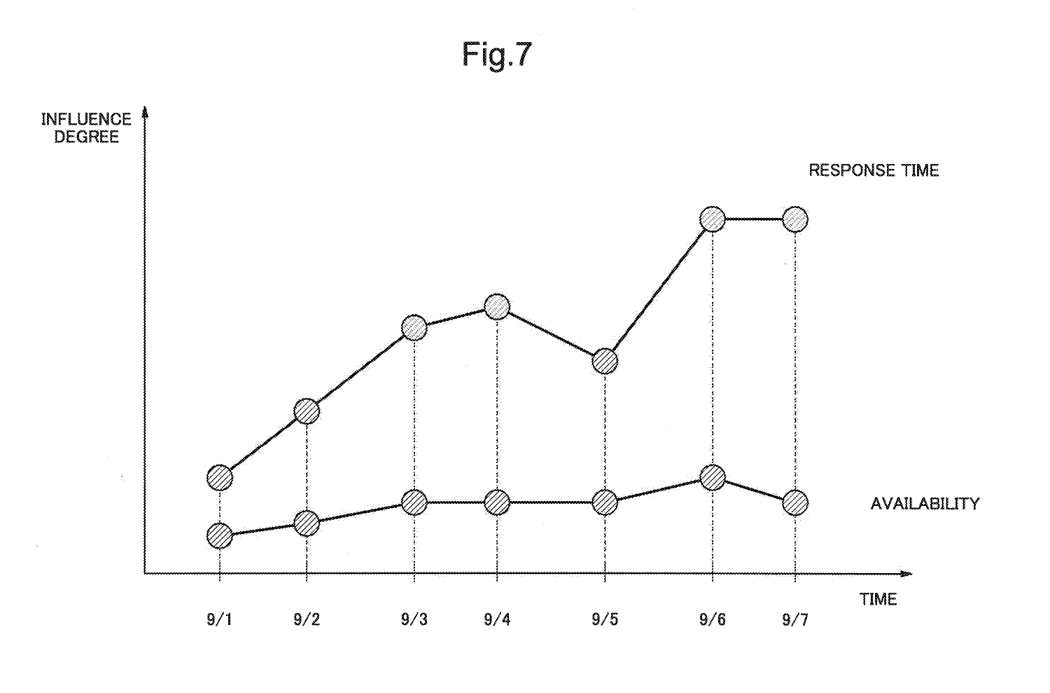

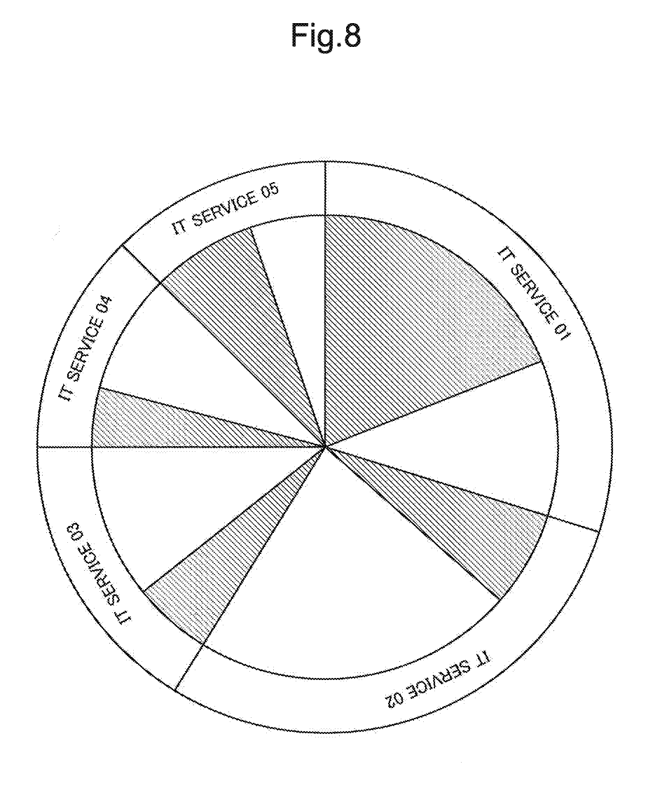

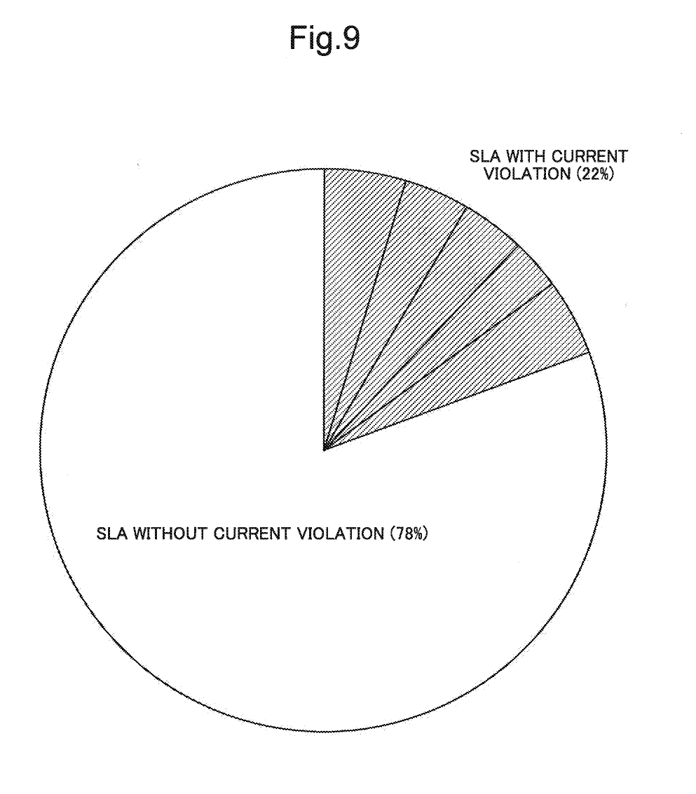

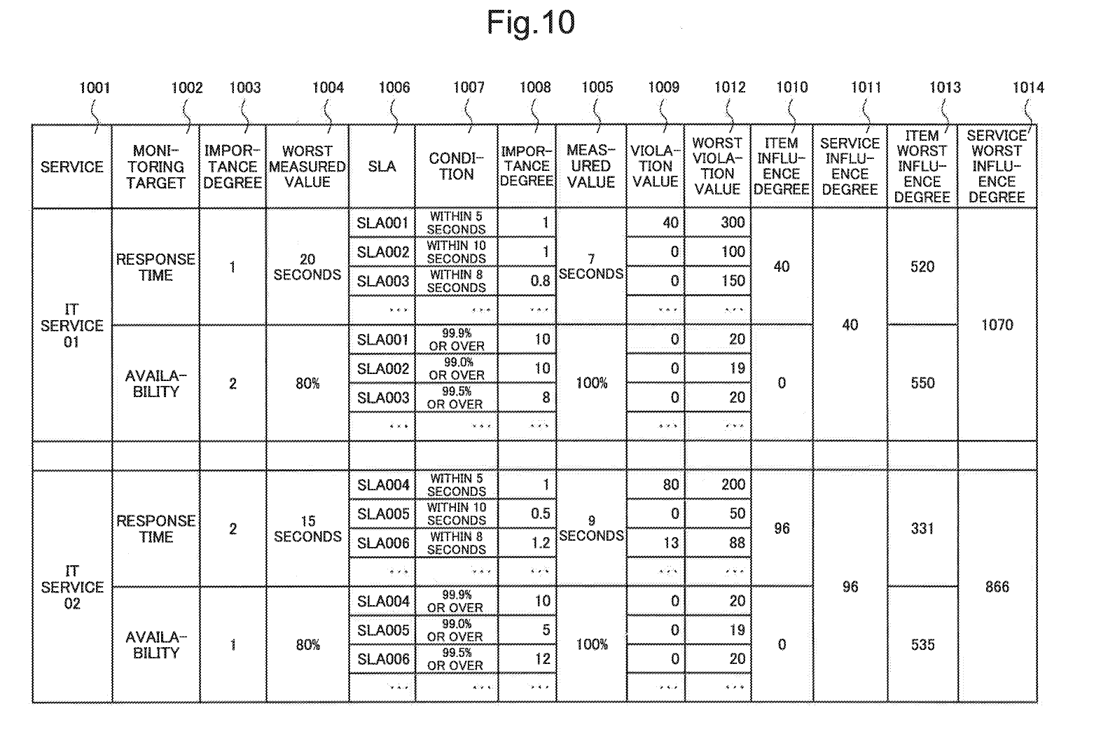

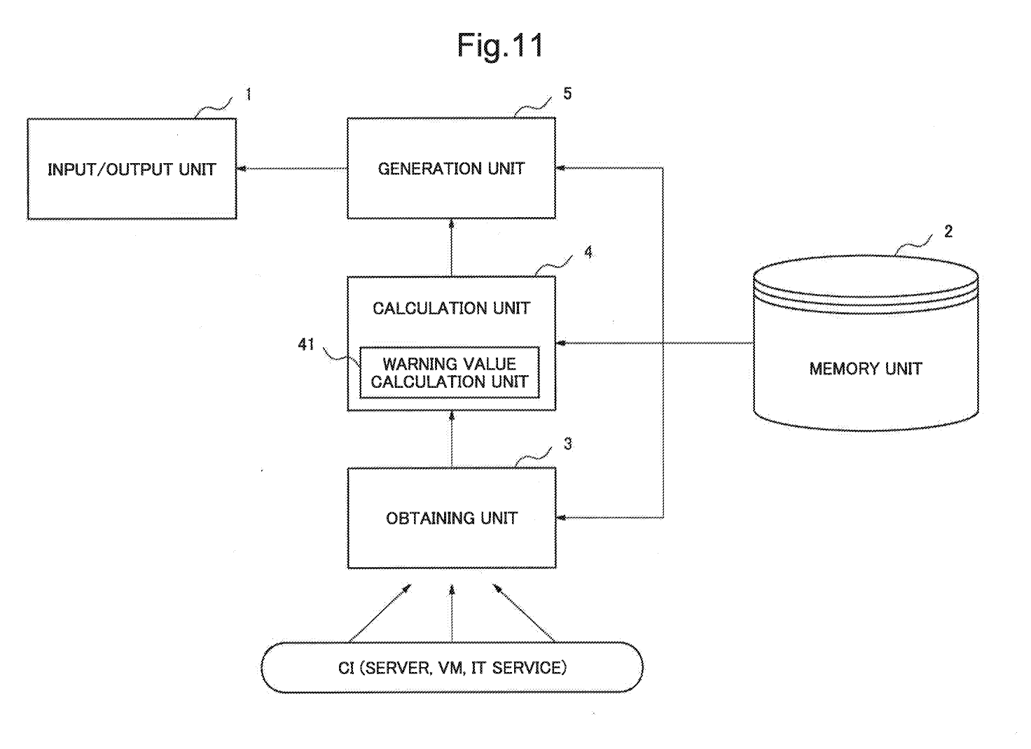

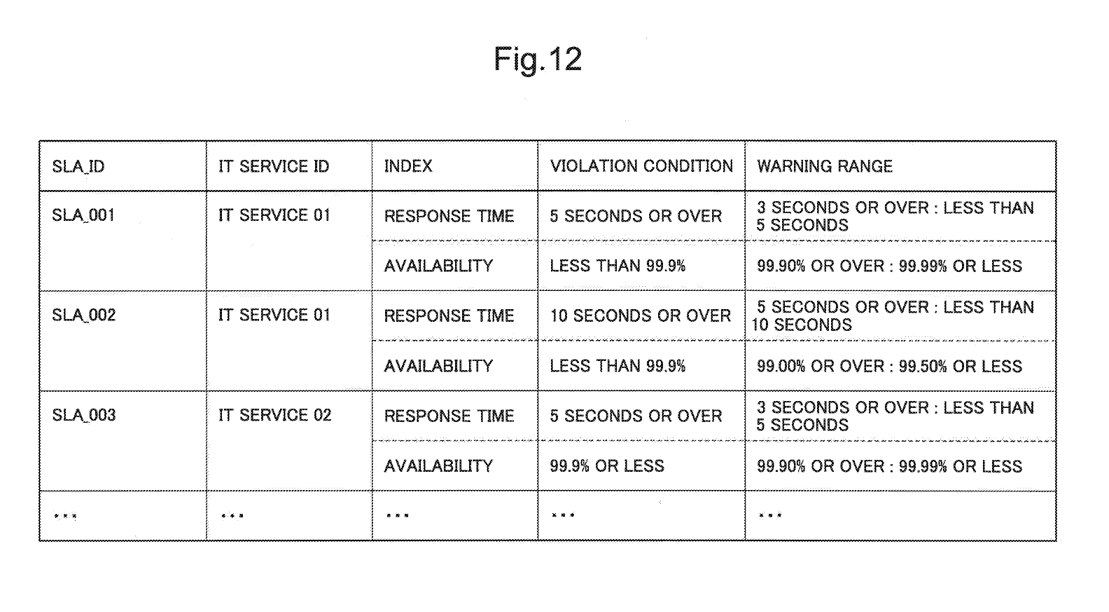

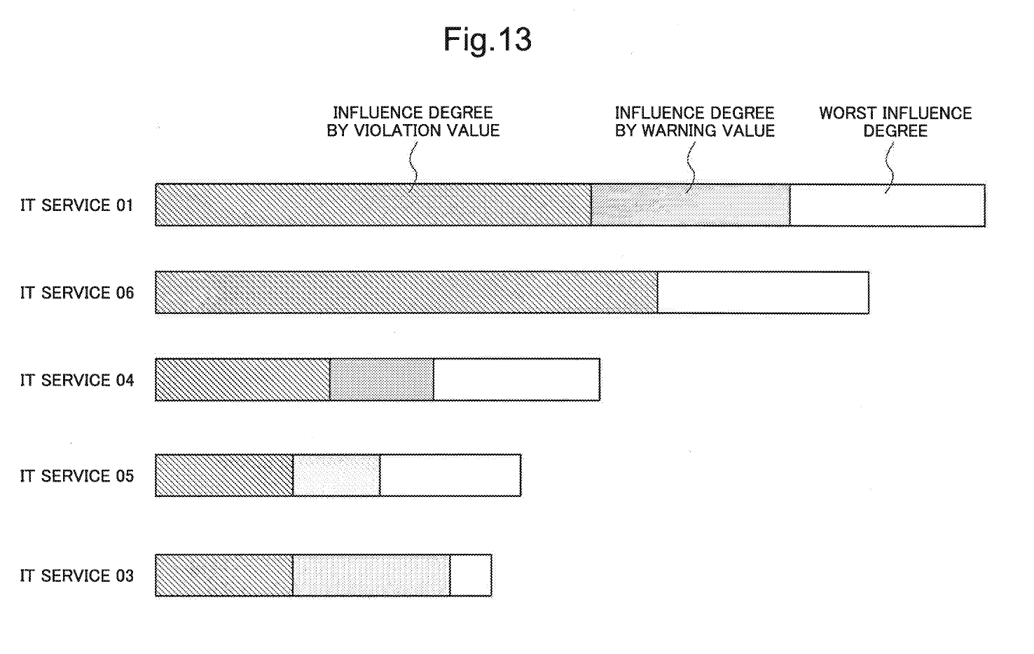

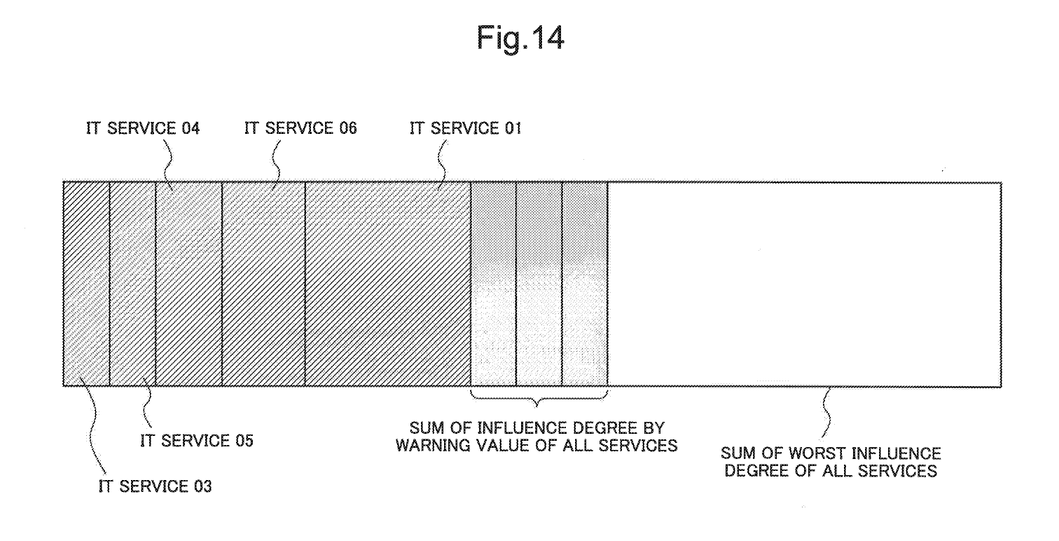

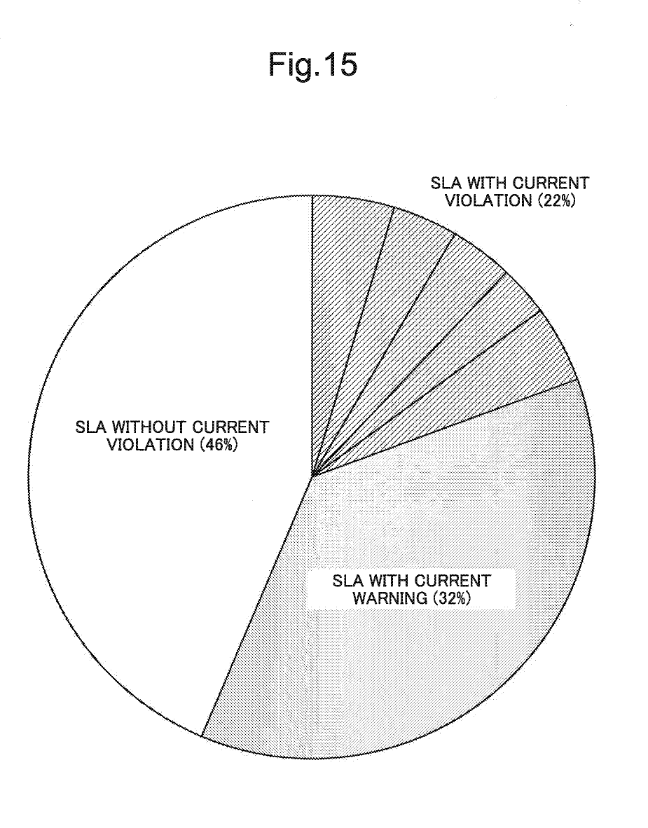

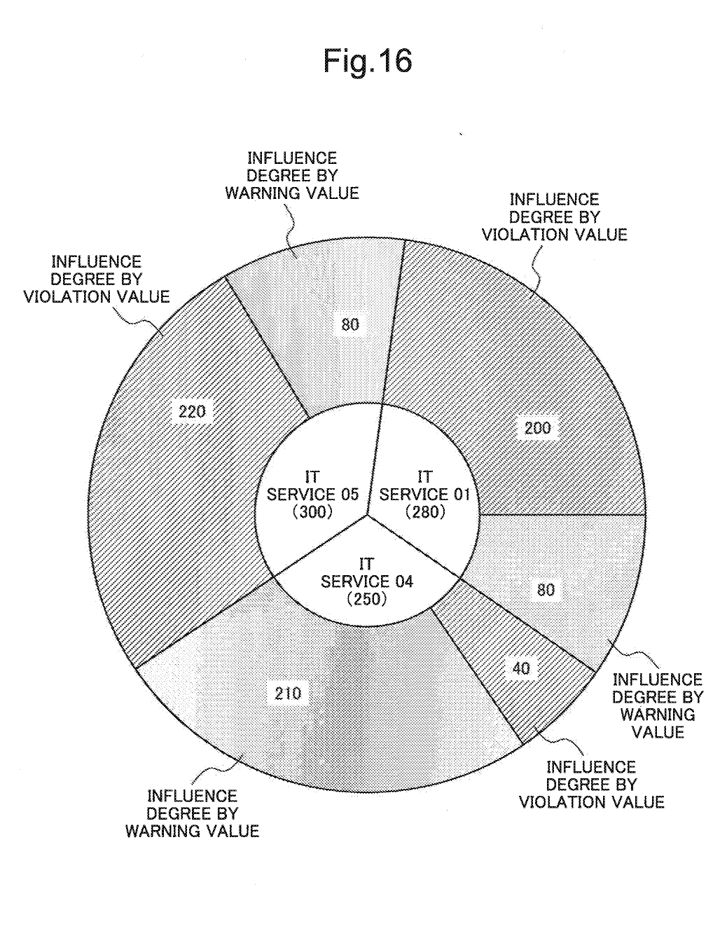

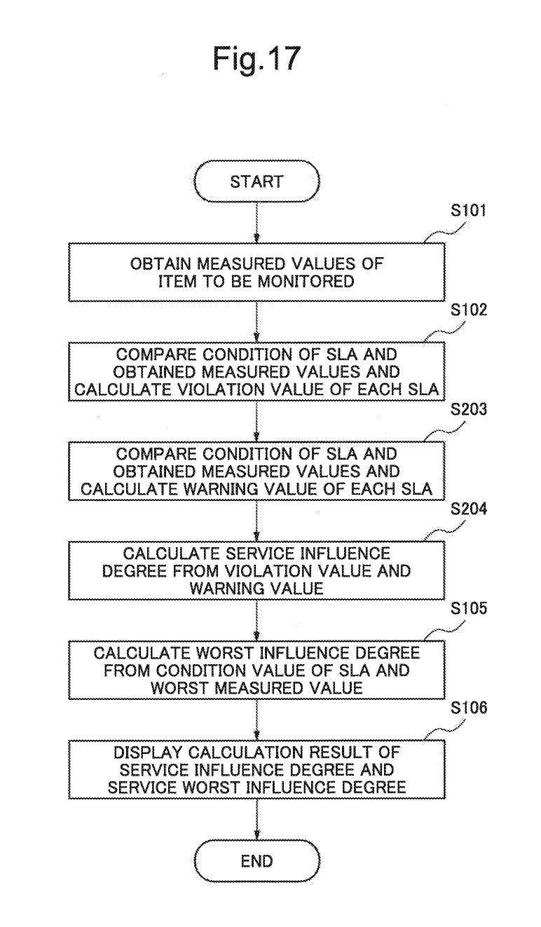

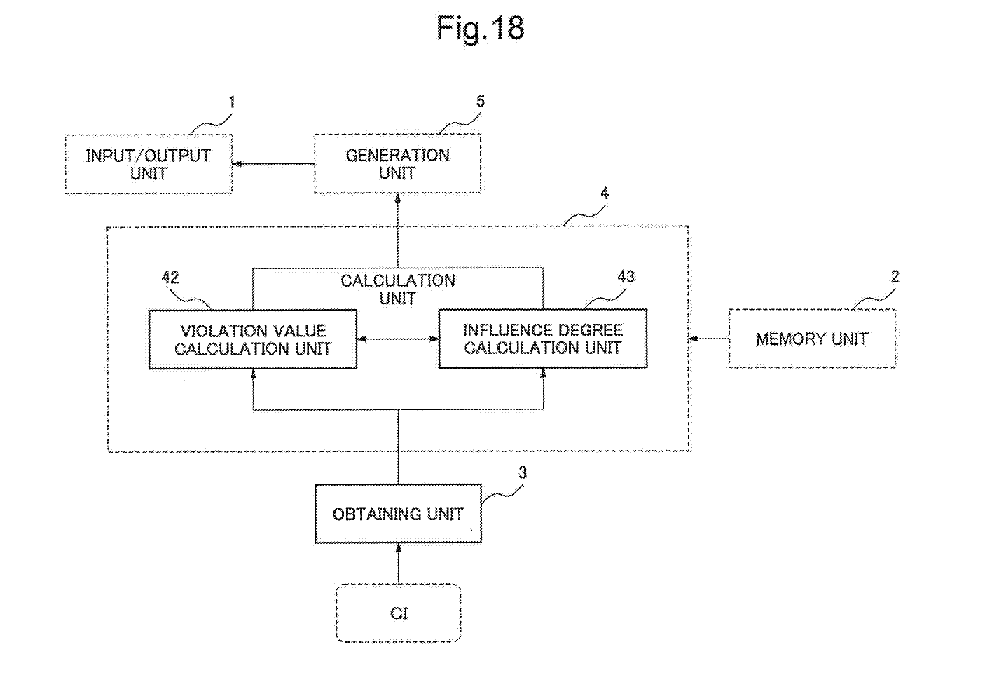

### BRIEF DESCRIPTION OF THE DRAWINGS

[FIG. 1] A flow chart indicating processing which calculates an influence degree in an influence degree calculation device according to the first exemplary embodiment of the present invention.

[FIG. 2] A block diagram indicating an exemplary configuration of an influence degree calculation device according to the first exemplary embodiment of the present invention.

[FIG. 3] A figure indicating an example of data registered in a memory unit of an influence degree calculation device according to the first exemplary embodiment of the present invention.

[FIG. 4] A figure indicating an example of data which an obtaining unit of an influence degree calculation device according to the first exemplary embodiment of the present invention outputs.

[FIG. 5] A figure indicating an image example which a generation unit of an influence degree calculation device according to the first exemplary embodiment of the present invention generates.

[FIG. 6] A figure indicating an image example which a generation unit according to the first exemplary embodiment of the present invention generates.

[FIG. 7] A figure indicating an image example which a generation unit according to the first exemplary embodiment of the present invention generates.

[FIG. 8] A figure indicating an image example which a generation unit according to the first exemplary embodiment of the present invention generates.

[FIG. 9] A figure indicating an image example which a generation unit according to the first exemplary embodiment of the present invention generates.

[FIG. 10] A figure indicating data obtained or calculated by an influence degree calculation device according to the first exemplary embodiment of the present invention.

[FIG. 11] A figure indicating an exemplary configuration of an influence degree calculation device according to the second exemplary embodiment of the present invention.

[FIG. 12] A figure indicating an example of data registered in a memory unit of an influence degree calculation device according to the second exemplary embodiment of the present invention.

[FIG. 13] A figure indicating an image example which a generation unit according to the second exemplary embodiment of the present invention generates.

[FIG. 14] A figure indicating an image example which a generation unit according to the second exemplary embodiment of the present invention generates.

[FIG. 15] A figure indicating an image example which a generation unit according to the second exemplary embodiment of the present invention generates.

[FIG. 16] A figure indicating an image example which a generation unit according to the second exemplary embodiment of the present invention generates.

[FIG. 17] A flow chart indicating processing which calculates an influence degree in an influence degree calculation device according to the second exemplary embodiment of the present invention.

[FIG. 18] A block diagram indicating an exemplary configuration of an information processing device according to the first exemplary embodiment of the present invention.

### DETAILED DESCRIPTION OF THE INVENTION

In the following, with reference to drawings, explanation will be made with respect to an exemplary embodiment of the present invention exemplarily and in detail. However, configuration components described in the following exemplary embodiment are an illustration to the end and are not intended to limit a technological scope of the present invention to them.

(Definition of Terms)

First, before explanation is made with respect to an exemplary embodiment of the present invention, required terms are defined.

“IT service (information service)” is an aggregate of IT functions which supports a service recipient using IT (Information Technology), and can be evaluated with respect to quality based on monitoring index. For example, the IT service includes an introduction management service of a mail system or an introduction management service of a business processing system.

“CI (Configuration Item)” is a configuration component for realizing the IT function included in the IT service. For example, it includes a server, VM (Virtual Machine, virtual machine), NW (Network) equipment, applications, processes, and so on.

“Failure” is made the phenomenon of a fault or a malfunction of the CI, and suspension of the IT service or deterioration of the monitoring index level caused by them.

“SLA (Service Level Agreement)” indicates a condition with agreement between an IT service provider and a service recipient relating to an IT service level. The SLA is, in general, an item relating to availability, reliability, performance and so on of the IT service, and one in which such a condition like “during a provided period of the IT service, TAT (Turn Around Time) is guaranteed to be no more than 5 seconds” is put into a numerical value. The SLA handled in this exemplary embodiment is supposed to be an item for which an agreement level is possible by numerical value expression. Examples of the items are TAT, number of redundant HW (Hardware), and so on. Also, the SLA mentioned here (exemplary embodiment) is not limited to a case where a word as SLA is specified in an agreement (condition) name, but is supposed to include all the agreement condition in which a numerical value agreement relating to a guarantee of a quality level of the IT service is included. In other words, in this exemplary embodiment, the SLA means a condition which is required relating to an item to be monitored.

Further, the SLA includes a case where, between an IT service provider and a plurality of service recipients, conditions are different with respect to IT service levels which are agreed separately.

### The First Exemplary Embodiment

The first exemplary embodiment of the present invention relates to a technology for grasping a provided state of an IT service, that is a service management technology which calculates an influence degree for an IT service at a time a failure occurred The first exemplary embodiment of the present invention is, in particular, an effective technology for a large scale system which includes, in large quantities, IT services, equipment which becomes an item to be monitored for providing an IT service, and service recipients who are provided IT services. By aggregating a threshold value violation with regard to a plurality of service contract information in one index, the first exemplary embodiment of the present invention calculates quality of the service concerned. The first exemplary embodiment of the present invention calculates evaluation of a plurality of contract information.

<Configuration>

FIG. 2 is a block diagram showing an exemplary configuration of an influence degree calculation device as an information processing device according to the first exemplary embodiment of the present invention. The influence degree calculation device indicated in FIG. 2 includes an input/output unit 1, an obtaining unit 3, a calculation unit 4, a generation unit 5, and a memory unit 2.

First, the input/output unit 1 includes an input device such as a mouse and a keyboard and an output device such as a display.

The memory unit 2 registers information of: linking (relationship) of a CI of a system and an IT service, linking (relationship) of an IT service and an SLA, an item of each SLA, and its numerical value condition (for example, a condition such as a TAT item guarantees to be within 5 seconds in an SLA_{—}01 which is one of SLAs).

The obtaining unit 3 collects, in real time, measured values of a monitoring index which is set for obtaining relating to a CI and an IT service which configure a system of a monitoring target, and outputs the information to the calculation unit 4.

With respect to the SLA which is linked (related) to the CI registered in the memory unit 2, the calculation unit 4 compares it with the measured values of the monitoring index obtained in the obtaining unit 3, and calculates a violation value which indicates a degree of violation of condition. In other words, the calculation unit 4 calculates for which SLA and to what extent it violates as a violation value quantitatively. And, the calculation unit 4 calculates, with respect to each IT service, a degree of influence which the SLA violation gives as an influence degree. Specifically, the calculation unit 4 calculates a sum of the violation values of a plurality of SLAs linked (related) to the IT service and makes this “influence degree”. Also, the calculation unit 4 calculates with respect to an influence degree, whose current measurement of a monitoring index is not in violation in the SLA, a worst influence degree in case the monitoring index becomes worst in the future.

An SLA is linked (related) to an IT service, and the IT service is often linked (related) to a CI which configures it (IT service). However, there is a case when an SLA is linked (related) to a CI directly. Such a configuration of those data depends on registered information in the memory unit 2.

The generation unit 5 is an image generation means which generates image data for displaying visually by such as a graph the influence degree, the worst influence degree, or both of them with respect to the CI and the IT service failure calculated in the calculation unit 4. If the generation unit 5 generates such an image data, it becomes possible to grasp at a glance such as presence of a problem and a seriousness degree of a system as a whole.

FIG. 3 is a figure indicating an example of a registered data 301 registered in the memory unit 2 of this exemplary embodiment. Each SLA_ID (identifier) is linked (related) to an IT service ID and, further, specific item of index and its numerical value condition are set. For example, an SLA_{—}001 is an SLA relating to an IT service 01 and has contents which guarantee a response time of within 5 seconds and availability of 99.9% or over. On the other hand, although an SLA_{—}002 is also an SLA relating to the IT service 01, in this SLA, the contents are to guarantee a response time of within 10 seconds and availability of 99.0% or over. Further, an SLA_{—}003 is an SLA relating to an IT service 02. In this SLA, the contents are to guarantee a response time of within 5 seconds and availability of 99.9% or over. Thus, by referring to the memory unit 2, the calculation unit 4 can derive what kind of condition can be satisfied with respect to a specific SLA. On the other hand, when a numerical value such as a response time and availability is given with respect to a specific IT service, the calculation unit 4 can derive to which SLA and to what degree it becomes a problem.

Further, the influence degree calculation device of this exemplary embodiment may assign a weight to each SLA. For example, although not indicated in FIG. 3, the influence degree calculation device may set an importance degree for each SLA in the memory unit 2. For example, the influence degree calculation device may set a relative importance degree to the SLA depending on such as a scale of a service recipient by making an importance degree of the SLA_{—}001 as 1, an importance degree of the SLA_{—}002 as 0.5, and an importance degree of the SLA_{—}003 as 0.3, and so on. By doing so, the influence degree calculation device can derive an importance with regard to a malfunction of the IT service correctly and comprehensively. Moreover, the SLA may be assigned a weight to each item of index.

FIG. 4 indicates an example of a measurement data 401 which the obtaining unit 3 collects and outputs to the calculation unit 4. The measurement data 401 makes, as an example, a response time and availability with respect to each CI to be monitored at a certain measurement time stamp an index of measurement target. Further, availability is generally obtained using a rate of an actual running time and a planned running time of an IT service. In the example, it is supposed that a planned running time in each IT service is set in advance, and the obtaining unit 3 calculates an actual running time after determining a running status based on measurement and calculates availability from that.

Referring to FIG. 3, as a condition which a response time of the IT service 01 should observe, the SLA_{—}001 specifies it to be within 5 seconds. In contrast, in the measurement data 401 of FIG. 4, the measured value of the response time relating to the IT service 01 is 7 seconds, and it violates the SLA_{—}001. In this case, since 7 seconds are 140% of 5 seconds and in excess of 40%, the calculation unit 4 can calculate a violation value relating to the response time as “40”.

Referring to FIG. 3, as a condition which availability of the IT service 01 should observe, the SLA_{—}001 specifies it to be 99.9% or over. In contrast, in the measurement data 401 of FIG. 4, the availability relating to the IT service 01 is 100%, and does not violate the SLA_{—}001. That is, since (SLA value)<=(equal or less) (actual measured value), the calculation unit 4 can calculate a violation value relating to the availability as “0”. Supposing that it is a case when the availability relating to the IT service 01 is 90% in the measurement data, (SLA value)<=(actual measured value) does not hold. Accordingly, since 90% is 90.1≈(nearly equal) 90% of 99.9% and is in short by 10%, the calculation unit 4 can calculate the violation value not as “0” but the violation value as “10”.

On the other hand, the calculation unit 4 can calculate a worst influence degree by specifying in advance a worst measured value with respect to each index item. For example, supposing that a worst response time of the IT service 01, the IT service 02 and the IT service 03 is 20 seconds respectively, a worst violation value of the SLA_{—}001 will be “300” (since 20 seconds are in excess of 300% of 5 seconds), a worst violation value of the SLA_{—}002 will be “100”, and a worst violation value of the SLA_{—}003 will be “300”. And, the calculation unit 4 multiplies the violation value by an importance degree of each SLA and calculates its sum as an influence degree. The influence degree of the IT service 01 indicated in FIG. 3 becomes, supposing that it is a sum of the influence degrees of the SLAs linked (related) to it (IT service 01), 40+0=40. Also, the worst influence degree becomes, as a sum of the worst influence degrees, 300+100=400.

Also, in case relation information of an IT service and a CI is registered in the memory unit 2, the calculation unit 4 can calculate an influence degree and a worst influence degree of the CI by tracing related IT services and SLAs using the information. The generation unit 5 displays a calculation result outputted from the calculation unit 4 on a screen.

FIG. 5 is a figure indicating an example of a graph image generated based on the generation unit 5. This bar graph indicates an influence degree and a worst influence degree relating to each IT service. The whole indicates the worst influence degree and a hatched part indicate the current influence degree. In FIG. 5, the generation unit 5 sorts the IT services based on a size of the worst influence degree and displays them. Further, the generation unit 5 may display the current influence degree or the worst influence degree according to the use. In FIG. 6, the generation unit 5 makes, beyond frames of IT services, a sum of the worst influence degrees in case items to be monitored of all the IT services being the worst measured values as a total length of the bar graph; and displays the current influence degree by hatching. Based on such a display, the generation unit 5 can display intuitively what degree of a problem occurred in all the SLAs of monitoring target.

In case of a graphic display, the generation unit 5 may graphically display an influence degree for each monitoring index such as a response times and availability separately as shown in FIG. 7 or may combine influence degrees in these pluralities of monitoring indexes (for example, using a weighted mean and so on) and graphically display it in a unified way. In FIG. 7, the generation unit 5 displays an item influence degree relating to a certain IT service in time series. The generation unit 5 totals data outputted from the calculation unit 4 based on a time stamp, and displays it. Display targets may be a plurality of IT services or may be a sum of influence degrees of all the IT services.

In FIG. 8, the generation unit 5 displays the same information as FIG. 5 in a pie chart. Same as FIG. 5, the generation unit 5 indicates a ratio (occupancy rate) of a current influence degree (hatched part) to a worst influence degree for each IT service and makes an IT service with a current influence degree as a display target. Also, in FIG. 9, the generation unit 5 displays in a pie chart a ratio of an SLAs with violation to all the SLAs which an IT service provider should observe.

<Processing>

Next, explanation will be made with respect to processing of this exemplary embodiment using FIG. 1 and FIG. 10. FIG. 1 is a flow chart showing an example of influence degree calculation processing of an IT service in the calculation unit 4. FIG. 10 is a table which collects data referred to and calculated by the flow chart of FIG. 1. First, the calculation unit 4 specifies an IT service for which an influence degree is to be obtained, reads information with respect to an item to be monitored required for calculation of an influence degree from the memory unit 2 among a CI required for the IT service, and further obtains measured values with respect to the item to be monitored from the obtaining unit 3 (S101). In FIG. 10, the calculation unit 4 specifies an IT service 01 and an IT service 02 as a service 1001. The calculation unit 4 reads a monitoring target 1002, an importance degree 1003, and a worst measured value 1004 for these services from the memory unit 2, and obtains a measured value 1005 from the obtaining unit 3.

Next, the calculation unit 4 reads information with respect to an SLA relating to the specified IT service from the memory unit 2. The SLA to be read corresponds to an SLA 1006, a condition 1007 and an importance degree 1008 in FIG. 10. And, the calculation unit 4 compares the condition 1007 and the measured value 1005 of each SLA and calculates a violation value 1009 of each SLA (S102). The calculation unit 4 may calculate the violation value 1009 from a difference or a ratio between an SLA contract value and a measured value of each index; or may express them by a binary value such as violation (x) and observed (o).

Next, the calculation unit 4 calculates an influence degree of an IT service based on the violation value of all the SLAs of the IT service (S104). As an influence degree of an IT service, a weighted sum which gives a weight to the violation value based on the importance degree of each SLA is used. In FIG. 10, as an example, the importance degree 1008 is defined for an SLA001 and an SLA002 as “1” and for an SLA003 as “0.8”. The calculation unit 4 can first calculate an influence degree for each item to be monitored (item influence degree 1010) based on multiplying each violation value by these values and summing them. And the calculation unit 4 can calculate an influence degree of an IT service (service influence degree 1011) by adding the item influence degree 1010. When the importance degree is “1” with respect to all the SLAs, the influence degree will be a simple sum of the violation values.

After calculating the service influence degree 1011, the calculation unit 4 calculates a worst violation value 1012 of each SLA using the worst measured value 1004 read and calculates a worst influence degree 1013 for each item and a worst influence degree 1014 for the IT services as a whole based on the worst violation value 1012 (S105). Finally, the generation unit 5 generates an image (forms taking FIGS. 5-9 as an example) which indicates a result of the IT service influence degree and the IT service worst influence degree calculated by S104 and S105 and displays it on the input/output unit 1 (S106).

### MODIFIED EXAMPLE

Further, each configuration of the information processing device according to this exemplary embodiment (influence degree calculation device) may be divided in a plurality of configurations. For example, the calculation unit 4 is not limited to one configuration, and it may be divided into a plurality of configurations, for example, a configuration which calculates a violation value and a configuration which calculates an influence degree. Also, each configuration may not be included in one device, and may be configured as different devices. For example, the memory unit 2 may be made a different memory device connected via a network. Also, the information processing device according to this exemplary embodiment may make the generation unit 5 and the input/output unit 1 as different devices.

FIG. 18 is a figure indicating an example of a different configuration of an information processing device according to this exemplary implementation (influence degree calculation device). In FIG. 18, same number is attached to a same configuration as FIG. 2, and detailed description is omitted.

The information processing device indicated in FIG. 18 includes the same obtaining unit 3 as FIG. 2, a violation value calculation unit 42 which calculates a violation value and an influence degree calculation unit 43 which calculates an influence degree. Further, the violation value calculation unit 42 and the influence degree calculation unit 43 operate altogether like the calculation unit 4 indicated in FIG. 2.

Also, the information processing device indicated in FIG. 18 makes the memory unit 2, the generation unit 5, and the input/output unit 1 different units connected via a network. Therefore, in FIG. 18, units connected via a network are indicated by a dotted line. Because a CI is also connected via a network, it is indicated by a dotted line.

The information processing device configured in this way (influence degree calculation device) can also exchanges information with each unit via a network, and can operate same as the influence degree calculation device indicated in FIG. 2.

Further, the information processing device indicated in FIG. 18 is a minimum configuration of the present invention.

### Effect of the First Exemplary Embodiment

The information processing device (influence degree calculation device) described so far can, in case a problem occurs to an IT service or a CI based on a failure, a malfunction and so on, provide a display to an IT service provider to confirm an influence to a SLA violation for each of the IT service, the CI or the IT system. Also, the information processing device can provide to the service provider clearly a possibility of how much the influence degree increases for each of them when the problem of the IT service or the CI are left just as it is.

As described above, the information processing device of this exemplary embodiment can notify influences relating to the SLA violation of the IT service or the CI based on a failure, a malfunction, and so on to the IT service provider. Also, the information processing device can make the IT service provider grasp easily an order of the IT service and the CI which should be handled with priority by displaying a influence degree calculation result as a graph and son on. In particular, in case a threshold value relating to a monitoring index in an IT service is decided from an SLA, the information processing device of this exemplary embodiment can reflect an influence to the IT service for each service recipient directly to a violation value, and a large effect can be expected with respect to correctness of influence degree calculation.

In other words, in case a problem occurs to a certain IT service, the information processing device of this exemplary embodiment can calculate a size of an influence from a viewpoint of a service recipient whom the problem affects.

Also, in case a problem occurs to a plurality of IT services and their handling becomes necessary, since the information processing device of this exemplary embodiment can calculate a size of an influence to an SLA for each IT service, it can provide a reference when an IT service provider performs priority ordering of the handling.
2012/05/08

### The Second Exemplary Embodiment

FIG. 11 is a block diagram indicating a configuration of an influence degree calculation device as the second exemplary embodiment. This exemplary embodiment is different, compared with the first exemplary embodiment indicated in FIG. 2, in a point that the calculation unit 4 includes a warning value calculation unit 41.

An example of data which is registered in the memory unit 2 according to this exemplary embodiment is indicated in FIG. 12. The difference with the registered data 301 of the memory unit 2 of the first exemplary embodiment indicated in FIG. 3 is that a warning range exists as data in addition to a violation range in each index (response time and availability) of an SLA. This warning range is not a violation with regard to an SLA with a service recipient, but is the range of a value with a high possibility to become a violation when left as it is without handling. Although it is different based on a property of an index, an example indicated in FIG. 12 makes a numerical value of one stage before becoming a violation as the warning range. For example, a response time of the SLA_{—}001 is normal when it is less than 3 seconds, a warning (risk) when it is 3 seconds or over and less than 5 seconds, and a violation when it is 5 seconds or over. Further, a threshold value other than a violation of an SLA can be set freely depending on a status of operation such that a risk value showing a range of a risk level with lower degree of handling urgency compared with the warning other than a threshold value showing a warning.

The calculation unit 4 calculates a warning value from a warning range set in each SLA and measured values obtained from the obtaining unit 3 in the warning value calculation unit 41. The warning value calculation unit 41 may express whether the measured values are included in the warning range by a binary value of within the warning range (o) and outside of the warning range (x) or may express at what location in the warning range it exists by a continuous value such as 25% of warning and so on. For example, in case a measured value of a response time of the IT service 01 being 7 seconds is obtained, since the warning ranges is 5 seconds or over and less than 10 seconds with respect to the SLA_{—}002, the warning value is within the warning range (o) or (7−5)/(10−5)*100=2/5*100=40%.

With respect to each SLA, the calculation unit 4 calculates an influence value for each IT service by also referring to a warning value calculated in the warning value calculation unit 41 in addition to a violation value obtained in the first exemplary embodiment. For example, the calculation unit 4 calculates a sum which weighed a violation value and a warning value. Supposing that the weight is “10” for a violation value and “2” for a warning value, and a violation value and a warning value of the SLA_{—}001 and the SLA_{—}002 are used, the calculation unit 4 can calculate an influence degree of the IT service 01 as 40*10+40*2=480 from the result of the SLA_{—}001 of the first exemplary embodiment.

FIG. 13 is a figure which displays a result of influence degree calculation of the second exemplary embodiment. The generation unit 5 displays so that sizes of a violation value and a warning value can be recognized for each IT service. For example, the generation unit 5 emphasizes an SLA with a violation value even if its number is small, and makes it easy to be reflected on a display.

FIG. 14 is a figure which makes a sum of a worst influence degree in case an item to be monitored of all the IT services is a worst measured value as a full length of a bar graph, and indicates an example which displayed an influence degree based on a violation value and an influence degree based on a warning value by hatching. The generation unit 5 can display intuitively what degree of a problem occurred in all the services based on such a display.

FIG. 15 is a figure indicating an example which displayed a result of influence degree calculation of the second exemplary embodiment. The generation unit 5 expresses the number of SLAs of all by a pie chart and displays a number of SLAs with a violation value and a number of SLAs with a warning value by a slant line and latticed pattern respectively. Based on this display, the influence degree calculation device can make an IT service provider grasp to what extent an SLA which requires handling exists among all the SLAs.

FIG. 16 is a figure indicating an example which displayed a result of influence degree calculation of the second exemplary embodiment. The generation unit 5 extracts IT services for which a violation value or a warning value exist and expresses contents of those violation values and warning values by a pie chart.

Referring to FIG. 17, operation of this exemplary embodiment is different in operation after calculating an SLA violation value in Step S102 from operation of the first exemplary embodiment. According to the second exemplary embodiment, after calculating the SLA violation value in Step S102, an SLA warning value is calculated in Step S203 by the warning value calculation unit 41.

<Processing>

With respect to a flow of processing of this exemplary embodiment, explanation will be made using FIG. 17. Since the differences from FIG. 1 indicated in the first exemplary embodiment are Step S203 and Step S204, and other processing is the same as that of the first exemplary embodiment, their description will be omitted here. In Step S203, the warning value calculation unit 41 compares a condition of each SLA and obtained measured values and calculates a warning value of each SLA (Step S203). The calculation unit 4 calculates an influence degree from the violation value and the warning value (Step S204).

### Effect of the Second Exemplary Embodiment

By defining a warning value in addition to a violation value, reflecting them to an influence degree for each IT service and CI, and providing them to a service provider, the information processing device (influence degree calculation device) of this exemplary embodiment can support further detailed understanding of a current observance state of the SLA and judging of an order of failure handling correctly.

### Other Exemplary Embodiments

Although explanation was made in detail with respect to an exemplary embodiment of the present invention above, a system or a device which are combined different features included in each exemplary embodiment in either way are also included in the scope of the present invention.

Also, the exemplary embodiment of the present invention may be applied to a system including a plurality of equipment or may be applied to a single device. Further, the present invention is applicable in case a service management program which realizes functions of the exemplary embodiment is supplied to a system or a device directly or from remote and is executed. Accordingly, a program which is installed in a computer in order to realize the function in each unit of the exemplary embodiment of the present invention mentioned above by a computer, a medium which stored the program, or a WWW server from which the program is downloaded are also included in the scope of the present invention. Also, a medium which stores the program may be the memory unit in FIG. 2, FIG. 11, and FIG. 18.

This application is based upon and claims the benefit of priority from Japanese Patent Application No. 2010-001968, filed on Jan. 07, 2010, the disclosure of which is incorporated herein in its entirety by reference.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be applied suitably for a use which grasps correctly a failure status in an operation monitoring field and deals with the failure. The present invention becomes useful, in particular, in case a plurality of failures occur simultaneously under a large scale system environment.

### DESCRIPTION OF SYMBOL

1 Input/output unit

2 Memory unit

3 Obtaining unit

4 Calculation unit

5 Generation unit

41 Warning value calculation unit

What is claimed is:

1.-10. (canceled)

11. An information processing device, comprising:
an obtaining unit which obtains measured values with respect to an item to be monitored relating to an information service;
a violation value calculation unit which compares a plurality of conditions required relating to said item to be monitored with said measured values, and calculates a violation value indicating a degree of violation of condition; and
an influence degree calculation unit which calculates a degree of influence which said violation of condition gives to said information service as an influence degree using said violation value.

12. The information processing device according to claim 11, wherein
said influence degree calculation unit refers to an importance degree set to each of said plurality of conditions and calculates said influence degree from said violation value.

13. The information processing device according to claim 11, wherein
said plurality of conditions which are different conditions with respect to service levels agreed separately between a provider of said information service and a plurality of recipients.

14. The information processing device according to claim 11, further comprising:
a warning value calculation unit which compares a plurality of conditions which becomes a target of warning relating to said item to be monitored with said measured values and calculating a warning value which indicates highness of possibility to become a violation of condition; wherein
said influence degree calculation unit calculates said influence degree using said violation value and said warning value.

15. The information processing device according to claim 11, further comprising:
an image generation unit which generates a graph image which shows said influence degree outputted from said influence degree calculation unit.

16. The information processing device according to claim 11, wherein
said influence degree calculation unit calculates a worst degree of influence which said information service can take as a worst influence degree using a worst violation value which is calculated by comparing said plurality of conditions and said worst measured value, in case a worst value considered as said measured value is made a worst measured value.

17. The information processing device according to claim 16, further comprising:
an image generation unit which generates a graph image which compares said influence degree and said worst influence degree outputted by said influence degree calculation unit.

18. A service management method, comprising:
obtaining measured values with respect to an item to be monitored relating to information service;
comparing a plurality of conditions required relating to said item to be monitored with said measured values and calculating a violation value indicating a degree of violation of condition; and
calculating a degree of influence which said violation of condition gives to said information service as an influence degree using said violation value.

19. A computer readable medium embodying a program, said program causing an information processing device to perform a method, said method comprising:
obtaining measured values with respect to an item to be monitored relating to an information service;
comparing a plurality of conditions required relating to said item to be monitored with said measured values, and calculating a violation value indicating a degree of violation of condition; and
calculating a degree of influence which said violation of condition gives to said information service as an influence degree using said violation value.

20. An information processing device, comprising:
an obtaining means for obtaining measured values with respect to an item to be monitored relating to an information service;
a violation value calculation means for comparing a plurality of conditions required relating to said item to be monitored with said measured values, and calculating a violation value indicating a degree of violation of condition; and
an influence degree calculation means for calculating a degree of influence which said violation of condition gives to said information service as an influence degree using said violation value.
